(19) United States
(12) Patent Application Publication
(10) Pub. No.: US 2011/0248549 A1
(43) Pub. Date: Oct. 13, 2011

(54) WELD-ON COMPOSITE TOOTH FOR ROLL CRUSHERS HAVING A CHROME CARBIDE BODY VACUUM BRAZED TO A MILD STEEL BACKING PLATE

(76) Inventor: Brook Hugh Knotts, Springville, UT (US)

(21) Appl. No.: 12/759,557

(22) Filed: Apr. 13, 2010

(51) Int. Cl. E21C 35/18; B23K 1/20; B23K 31/02

(52) U.S. Cl. 299/105; 228/124.1

(57) ABSTRACT

A durable, weld-on chrome carbide tooth is provided for roll crushers. The tooth includes a chrome carbide body that is vacuum brazed to a mild steel backing plate. An upper portion of the tooth is preferably cast from chrome carbide alloy having 25 percent high-chrome-molybdenum content and a Brinell Hardness Number of about 700. The mating surfaces of the chrome carbide body and the mild steel backing plate are surface ground, then brazed together in a heat-treating furnace that has been evacuated to a pressure of less than 1×10⁻³ Torr. The minor differences in thermal expansion coefficients of the chrome carbide body and the mild steel backing plate are absorbed in the brazed joint, thereby reducing the buildup of mechanical stresses at the boundary layer. The mild steel backing plate enables the tooth to be welded directly to the drum of a rotary crusher.

### BACKGROUND OF THE INVENTION

1. Field of the Invention

This invention relates to teeth for roll crushers and, more particularly, to teeth which are welded to the outer surface of roll crusher drums.

2. Description of the Prior Art

Roll crushers are compression type crushers widely used extensively in mining operations. There are two basic types of roll crushers. The first employs a single roll operating adjacent a curved stationary anvil plate. The second employs two counter-rotating rolls having parallel axes and a gap between the rolls. Particle output size is determined, in the case of a single roll crusher, by the gap between the roll and the anvil plate or, in the case of a double-roll crusher, by the gap between the rolls. During the operation of a roll crusher, large particles are drawn into the gap by the rotating motion of the roll or rolls and a friction, or nip, angle formed between either the single roll and its adjacent anvil plate or between the two rolls of the double-roll crusher and the particle. As the large particles are forced into an ever smaller gap, compressive forces fracture the particles. Roll crushers have a theoretical maximum reduction ratio of 4:1. Thus, if an 8-inch diameter particle is fed to the roll crusher the absolute smallest size one could expect from the crusher is a 2-inch diameter particle.

Though once widely used to crush mined mineral-ore-containing rock, the use of roll crushers in that application has declined during the past decade as low-cost, low-maintenance cone crushers have largely taken over the task. However, because the output from roll crushers has a very narrow size distribution and very little dust or fines is produced during the crushing process, roll crushers are still widely used in coal mining operations. Whereas roll crushers used to crush mineral and metal ores have smooth faced rolls, those used for crushing coal have teeth or other topography attached to the rolls.

If a coal seam is not too far beneath the surface, the coal is most easily mined with the greatest percentage of coal recovery by removing the overburden to expose the coal seam and, then, blasting and removing the coal. This is known as surface mining. Surface mining of coal has become widespread where coal seams are relatively close to the surface. The ratio of overburden excavated to the amount of coal removed is called the overburden ratio. The lower the ratio, the more productive the mine. The lowest overburden ratios are found in western surface mines. In Appalachia, often more than one coal seam is mined.

There are several types of surface coal mines. Area surface mines, usually found in flat terrain, consist of a series of cuts 100 to 200 feet wide. The overburden from one cut is used to fill in the mined out area of the preceding cut. Contour mining, occurring in mountainous terrain, follows a coal seam along the side of the hill. When contour mining becomes too expensive, additional coal can often be produced from the mine's highwall by the use of augers or highwall miners. Open pit mines are usually found where coal seams are thick, and can reach depths of several hundred feet.

Equipment used in surface mines include draglines, shovels, bulldozers, front-end loaders, bucket wheel excavators and trucks. In large mines, draglines remove the overburden while shovels are used to load the coal. In smaller mines, bulldozers and front-end loaders are often used to remove overburden. However, when it coal seam is too far beneath the surface to make surface mining practical, underground mining is used.

If it is not practical to remove the overburden covering a coal seam, the seam must be mined using underground mining methods. Most underground coal is mined by the room and pillar method, whereby rooms are cut into the coal bed leaving a series of pillars, or columns of coal, to help support the mine roof and control the flow of air. Generally, rooms are 20-30 feet wide and the pillars up to 100 feet wide. As mining advances, a grid-like pattern of rooms and pillars is formed. When mining advances to the end of a panel or the property line, retreat mining begins. In retreat mining, the workers mine as much coal as possible from the remaining pillars until the roof falls in. When retreat mining is completed, the mined area is abandoned. There are two methods to extract the coal using room and pillar mining: conventional mining and continuous mining. Conventional mining is the oldest method, and now accounts for only about 12% of underground coal output. In conventional mining, the coal seam is cut, drilled, blasted and then loaded into cars. Continuous mining is now the most prevalent form of underground mining, accounting for about 56% of total underground production. In continuous mining, a machine known as a continuous miner cuts the coal from the mining face, obviating the need for drilling and blasting.

The longwall method of underground coal mining, which was implemented during the latter half of the twentieth century, is generally considered to represent the most revolutionary advance in coal mining technology in history. Longwall mining now accounts for about 31% of underground coal production. There are about 100 longwall operations in the United States, with most of them being in Appalachia. In longwall mining, a cutting head moves back and forth across a panel of coal about 800 feet in width and up to 7,000 feet in length. The cut coal falls onto a flexible conveyor for removal. Longwall mining is done under hydraulic roof supports (shields) that are advanced as the seam is cut. The roof in the mined out areas falls as the shields advance. About ninety percent of the coal within a seam is recoverable using the method.

Roll crushers are typically used to treat the output of both surface mines and underground mines so that lumps of the mined coal measure no more than 5.0 cm (about 2.0 inches) across. This is generally the maximum size that coal-fired power plants are willing to accept. Such crushers are generally of the dual-roll type, and are manufactured by companies such as Joy Mining Machinery, Inc. and McLanahan Corporation. The crushers typically utilize a rotary drum to which teeth are affixed. U.S. Pat. No. 4,807,820 to Theodore F. Gundlach discloses a segmental shell for a coal crusher roll. The teeth are clearly visible on the segmental shell of the drawings.

In the interest of permanently securing the teeth to crusher rolls, teeth are welded to the cylindrical surface of the crusher roll. Although welding the teeth to the roll greatly enhances overall durability of the roll, replacing worn-out or broken teeth is no simple task. When the drum is rebuilt, the worn-out teeth must be cut from the outer surface of the drum, and new teeth welded to the drum to replace those that have been cut off. The process is labor intensive and costly. Clearly, the longer the longer the life expectancy of the attached teeth, the longer the drum can be productively used, and the less the downtime required for rebuilding the drum.

Four basic types of teeth are presently manufactured for use on crusher rolls. The first type is a cast steel tooth having hard facing welded on the wear surface. Each tooth of this type sells for about $15.00. In continuous service, such a tooth lasts only about four weeks.

The second type of tooth is a cast steel tooth having tungsten carbide chips welded onto the wear surface. Each tooth of this type sells for about $35.00. The problem with this type of tooth is that after the tungsten carbide chips are worn off, the tooth becomes rounded and stops crushing the coal. In continuous service, such a tooth lasts about 12 weeks.

The third type of tooth is a cut steel tooth having a welded-on cast mild steel bar with tungsten carbide chips cast into the wear face. The tooth may also include welded-on hard facing. Each such tooth sells for about $48. This type of tooth suffers from a number of drawbacks: the casting of tungsten carbide chips is a slow and difficult process, resulting in high manufacturing costs; and when the tungsten carbide chips are worn off, the tooth is, effectively, unusable. In continuous service, a tooth of this type also lasts about 12 weeks.

The fourth type of tooth is a mild steel tooth having tungsten carbide chips cast into the wear face. The primary problem with this type of tooth is cost, as the casting of tungsten carbide chips is a difficult and slow process. The chips are gravity fed into the molten mild steel as the casting is poured. The process results in the presence of chips only on the face of the tooth. Although each tooth of this type sells for about $54.00, it lasts only about 12 weeks in continuous service.

The focus of the present invention is the manufacture of a more durable tooth that greatly extends the useful life of the rotary drums used in roll crushers.

### SUMMARY OF THE INVENTION

The present invention provides a durable, weld-on chrome carbide tooth for roll crushers. The tooth includes a chrome carbide body that is vacuum brazed to a mild steel backing plate.

Brazing, as defined by the American Welding Society (AWS), is a metal-joining process whereby a filler metal or alloy is heated to melting temperature above 450° C. (842° F.) and distributed between two or more close-fitting parts by capillary action. The filler metal is brought slightly above its melting (liquidus) temperature while protected by a suitable atmosphere or flux. It then interacts with a thin layer of the base metal (known as wetting) and is then cooled rapidly to form a sealed joint. By definition, the melting temperature of the braze alloy is lower-often, substantially lower-than the melting temperature of the materials being joined. Brazed joints are generally stronger than the individual filler metals used due to both the geometry of the joint and the metallurgical bonding that occurs at the interface of each base metal component and the filler metal. At the interface, a very thin matrix of filler metal atoms and base metal atoms is formed. In order to maximize the strength of brazed joints, base metal parts must be exceptionally clean and free of oxide and surfaces must be closely fitted to minimize the thickness of a pure filler material layer between the joined base metal components. For this reason, joint clearances of 0.03 to 0.08 mm (0.002 to 0.003 in) are recommended for the best capillary action and joint strength. Such tolerances are typically achieved through surface grinding of the mating surfaces.

Vacuum brazing is a term for various metal joining or brazing processes that take place in a chamber or retort at very low atmospheric pressures, rather than in the presence of a protective gas atmosphere used in other heat treating furnaces. Furnaces are categorized as hot wall or cold wall, depending on the location of the heating and insulating components. Cold wall furnaces are generally used for vacuum brazing operations. Assemblies removed from the furnace after vacuum brazing are bright and clean (shiny) because the extremely low amount oxygen in the furnace chamber prevents oxidation of the treated parts. Vacuum brazing is particularly useful where base metals are processed that adversely react with other atmospheres, or where entrapped fluxes or gases are intolerable. Vacuum brazing offers the combination of high cleanliness, as well as uniform heating and cooling of the brazed parts.

Chromium carbide (most commonly Cr₃C₂) is an extremely hard refractory ceramic material having a melting point of 1895° C. It is usually produced using a sintering process. Prior to casting under heat and pressure, it has the appearance of a gray powder with orthorhombic crystal structure. The orthorhombic Cr₃C₂ occurs naturally as the extremely rare mineral tongbaite. Other formulations of chromium carbide are also available, including the cubic compound Cr₂₃C₆ (occurring naturally as the extremely rare cubic-structured mineral isovite) and Cr₇C₃. The thermal expansion coefficient of chromium carbide is almost equal to that of steel.

For the present invention, the upper portion of the tooth is cast from a durable chrome carbide (Cr₃C₂) alloy having 25 percent high-chrome-molybdenum content and a Brinell Hardness Number (BHN) of 700. The mating surfaces of the chrome carbide body and the mild steel backing plate are surface ground, then brazed together in a heat-treating furnace that has been evacuated to a pressure of less than 1×10⁻³ Torr. The minor differences in thermal expansion coefficients of the chrome carbide body and the mild steel backing plate are absorbed in the brazed joint, thereby reducing the buildup of mechanical stresses at the boundary layer. The mild steel backing plate enables the tooth to be welded directly to the drum of a roll crusher.

### BRIEF DESCRIPTION OF THE DRAWINGS

FIG. 1 is an isometric view of the chrome carbide body, taken from an upper right front vantage point;

FIG. 2 is an isometric view of the chrome carbide body, taken from a lower left front vantage point;

FIG. 3 is an isometric view of the mild steel backing plate, taken from an upper right front vantage point;

FIG. 4 is an isometric view of the mild steel backing plate, taken from a lower left front vantage point;

FIG. 5 is an isometric view of the mild steel backing plate, taken from an upper left rear vantage point, after it has been coated with a brazing compound layer;

FIG. 6 is an exploded view isometric of the tooth prior to assembly and vacuum brazing;

FIG. 7 is an isometric view of the assembled and vacuum-brazed tooth;

FIG. 8 is a front elevational view of the assembled and vacuum-brazed tooth;

FIG. 9 is a side elevational view of the assembled and vacuum-brazed tooth;

FIG. 10 is a top plan view of the assembled and vacuum-brazed tooth; and

FIG. 11 is a rear elevational view of the assembled and vacuum-brazed tooth.

### DETAILED DESCRIPTION OF THE INVENTION

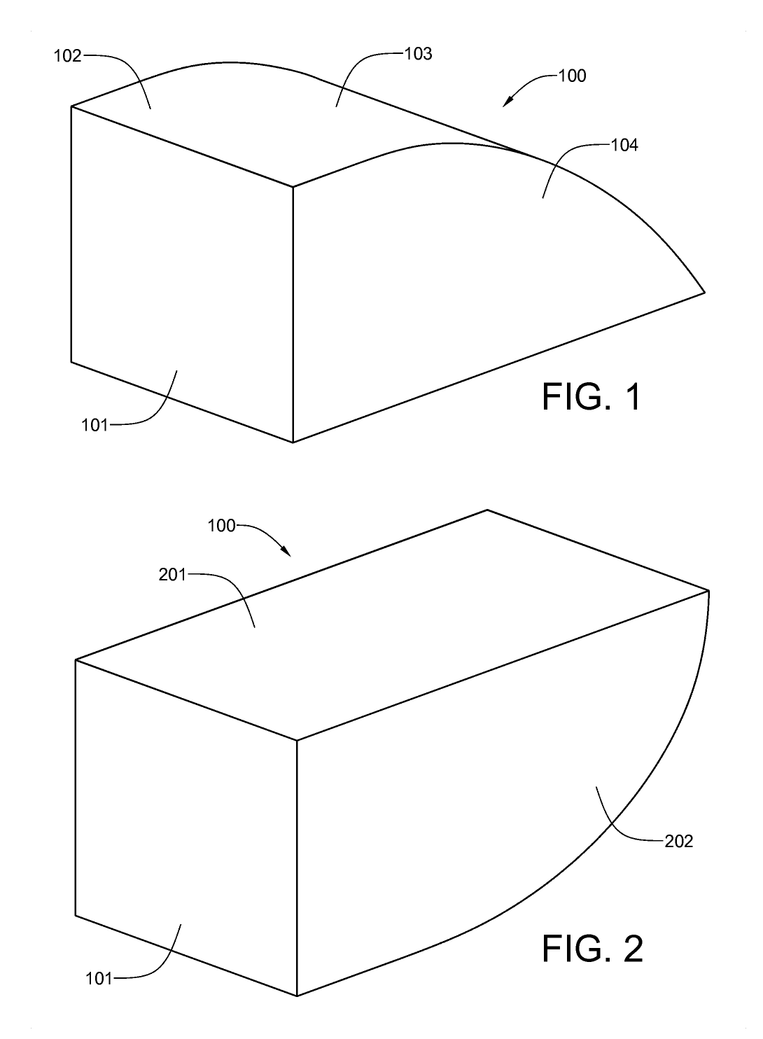

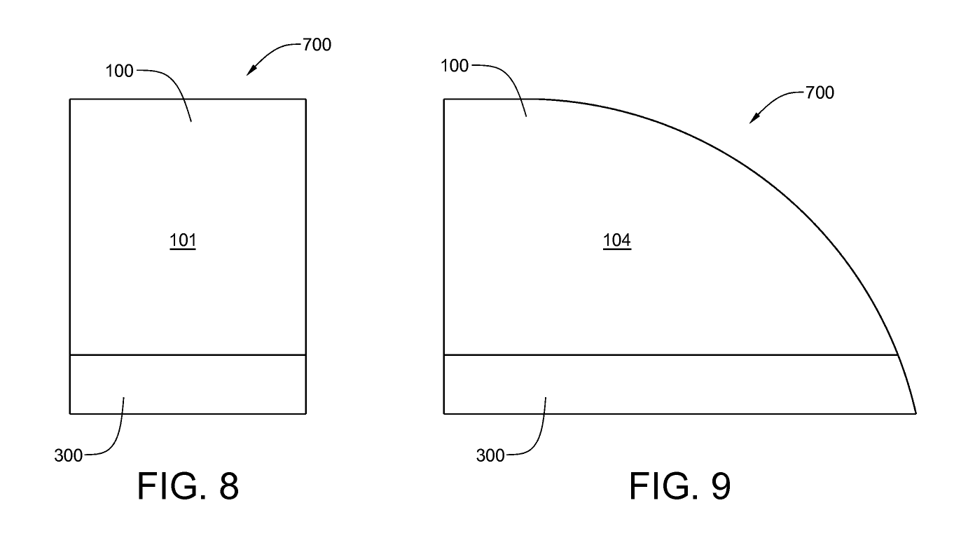

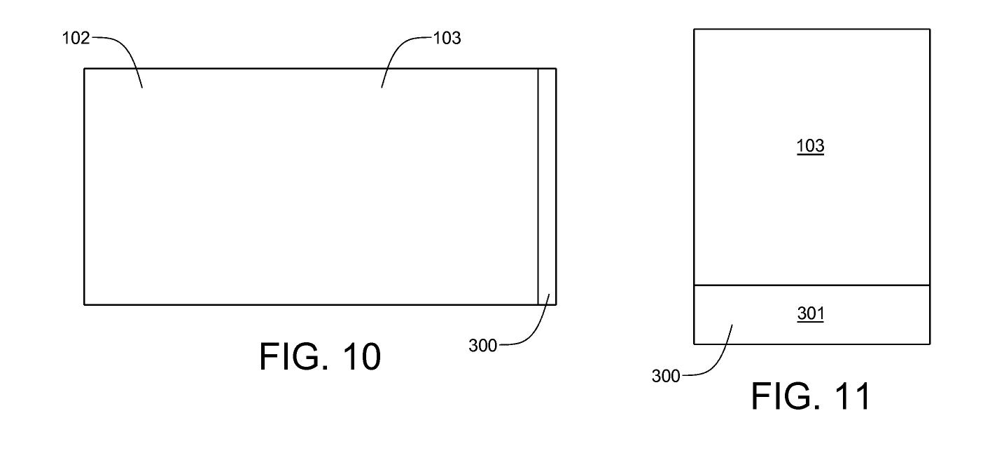

The invention will now be described with reference to the attached drawing FIGS. 1 through 11. It should be understood that although the drawings are intended to be merely illustrative, a reasonable attempt has been made to provide drawings which are close to scale.

Referring now to FIG. 1, a chrome carbide tooth wear body 100 is preferably cast from a chrome carbide (Cr₃C₂) alloy having about 25 percent high-chrome-molybdenum content and a Brinell Hardness Number (BHN) of about 700. The tooth wear body 100 has a generally vertical planar front face, a generally planar horizontal upper surface front portion 102, a simple-downwardly-curving upper surface rear portion 103 contiguous with the upper surface front portion 102, and a generally vertical planar right face 104.

Referring now to FIG. 2, the chrome carbide wear body 100 also has a generally planar horizontal lower face 201 and a generally vertical planar left face 202. The lower face 201 of the surface 102 of the wear body 101 is ground flat so that there is no variance from absolute planarity greater than about 0.01 to 0.04 mm (0.0004 to 0.0012 in).

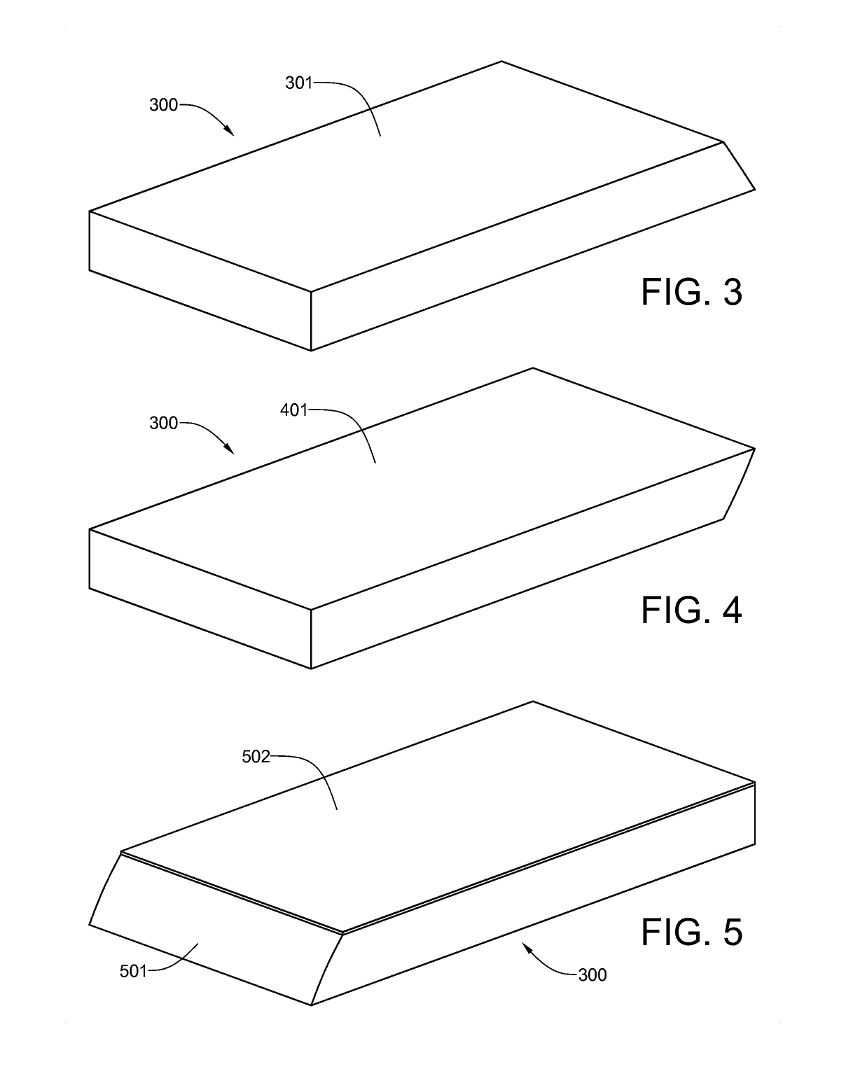

Referring now to FIG. 3, a tooth backing plate 300 is fabricated from mild steel. The upper surface 301 of the backing plate 300 is also ground to the same tolerances as the lower face 201 of the wear body 100. For a preferred embodiment of the crusher roll tooth, the backing plate 300 is about 3.0 inches in length, 1.5 inches in width, and 0.375 inches in height.

Referring now to FIG. 4, the mild steel tooth backing plate 300 has a generally planar lower surface 401.

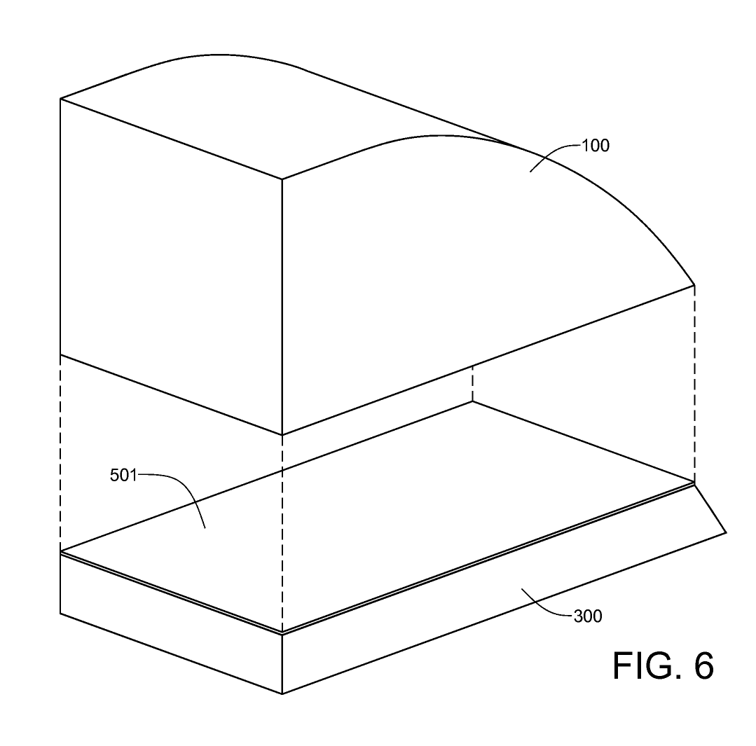

Referring now to FIG. 5, it will be noted that the rear face 501 of the backing plate 300 is angled. It will be further noted that the surface-ground upper surface 301 of the backing plate has been coated with a brazing compound layer 502 that is either in the form of a powder or a ductile amorphous foil. In either case, the brazing compound layer 502 has a thickness of about 0.1 mm to 0.15 mm (about 0.004 inch to about 0.006 inch). For a preferred embodiment of the invention, a brazing alloy high in nickel content, such as a copper-manganese nickel brazing alloy is used.

Referring now to FIG. 6, the chrome carbide wear body 100 and the mild steel backing plate 300 of the new roll crusher tooth are shown before they are joined in a vacuum brazing process by the brazing compound layer 502.

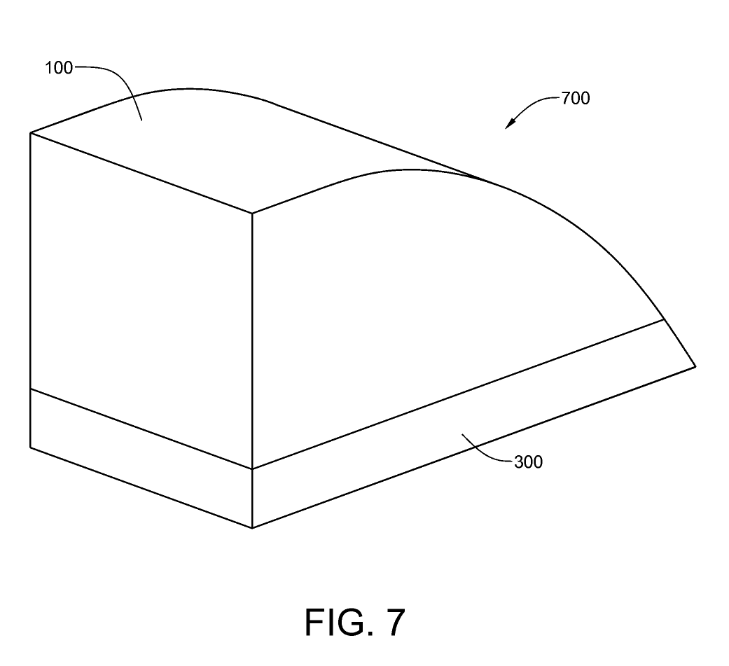

Referring now to FIGS. 7, 8, 9, 10 and 11, the chrome carbide wear body 100 and the mild steel backing plate 300 have been joined as a single unit by placing the wear body 100 on top of the brazing compound layer 502 and subjecting the assembly to high temperature and subsequent cooling in a heat treating oven at a pressure of less than 1×10⁻³ Torr. Extra brazing compound from brazing compound layer 502 is squeezed out of the joint by the weight of the chrome carbide wear body 100, resulting in a joint having an absolute minimum of non-matrixed brazing compound between the precision ground surfaces of the wear body 100 and the backing plate 300. For a preferred embodiment of the invention, the completed tooth 700 is about 5.1 cm (2.0 inches) in height, 3.8 cm (1.5 inches) in width, and 7.6 cm (3.0 inches) in length. Once the tooth is completely assembled and vacuum brazed, the mild steel backing plate 103 can be welded directly to the cylindrical surface of a crusher roll, which is typically also fabricated from mild steel.

The new composite cast chrome carbide and mild steel tooth is projected to have a unit price of about $45.00 and last about 20 weeks in continuous service. This represents about a 6 percent reduction in cost and about a 67 percent increase in durability compared to the prior art cut steel tooth having the mild steel bar with tungsten carbide chips cast into the wear face is a mild steel tooth having tungsten carbide chips cast into the wear face. Compared to the mild steel tooth having cast-in tungsten carbide chips in the wear face, the new composite cast chrome carbide and mild steel tooth represents about a 17 percent reduction in cost and about a 67 percent increase in durability.

Although only a single embodiment of the invention has been shown and described, it will be obvious to those having ordinary skill in the art that changes and modifications may be made thereto without departing from the scope and the spirit of the invention.

What is claimed is:

1. A wear-resistant tooth weldable to a drum of a roll crusher, said tooth comprising:
a chrome carbide wear body having a generally planar bottom surface; and
a mild steel backing plate braze-joined to said bottom surface of the chrome carbide wear body.

2. The wear-resistant tooth of claim 1, wherein said chrome carbide wear body is cast from a chrome carbide (Cr₃C₂) alloy having about 25 percent high-chrome-molybdenum content and a Brinell Hardness Number (BHN) of about 700.

3. The wear-resistant tooth of claim 1, wherein said wear body and said backing plate are braze-joined in a heat treating oven at a pressure less than 1×10⁻³ Torr.

4. The wear-resistant tooth of claim 1, wherein said wear body and said mild steel backing plate are joined with a brazing alloy containing nickel, copper and manganese.

5. The wear-resistant tooth of claim 1, wherein said wear body has a generally vertical planar front face, adjoining generally parallel, vertical planar side faces, and an upper surface that is generally horizontal and planar adjacent the front face, said upper planar upper surface transitioning to a downwardly curving upper surface that makes a pointed edge with a planar lower surface.

6. The wear-resistant tooth of claim 1, wherein mating surfaces of the wear body and the backing plate are precision ground so that there is no variance from absolute planarity greater than about 0.01 to 0.04 mm.

7. A process for manufacturing a wear-resistant tooth weldable to an outer surface of a roll crusher drum, said process comprising the steps of:
casting a wear body from chrome carbide alloy having a bottom planar surface;
grinding said bottom surface so that there is no variance from absolute planarity greater than about 0.01 to 0.04 mm;
fabricating a mild steel backing plate having upper and lower parallel planar surfaces, said upper surface having dimensions generally identical to those of said bottom planar surface;
grinding said upper planar surface so that there is no variance from absolute planarity greater than about 0.01 to 0.04 mm; and
joining said bottom planar surface to said upper planar surface via a brazing operation.

8. The process of claim 7, wherein said chrome carbide wear body is cast from a chrome carbide (Cr₃C₂) alloy.

9. The process of claim 8, wherein said chrome carbide alloy has about 25 percent high-chrome-molybdenum content and a Brinell Hardness Number (BHN) of about 700.

10. The process of claim 7, wherein said brazing operation is performed in a heat treating oven at a pressure less than 1×10⁻³ Torr.

11. The process of claim 7, wherein said brazing operation utilizes a brazing alloy containing nickel, copper and manganese.

12. The process of claim 7, wherein said wear body has a generally vertical planar front face, adjoining generally parallel, vertical planar side faces, and an upper surface that is generally horizontal and planar adjacent the front face, said upper planar upper surface transitioning to a downwardly curving upper surface that makes a pointed edge with a planar lower surface.

13. A wear-resistant tooth weldable directly to a drum of a roll crusher, said tooth comprising:
a chrome carbide wear body; and
a mild steel backing plate braze-joined to a lower surface of the chrome carbide wear body tungsten carbide insert installed and silver brazed in each transverse groove, each carbide insert extending an entire width of said cast carbon steel body.

14. The wear-resistant tooth of claim 13, wherein said chrome carbide wear body is a casting.

15. The wear-resistant tooth of claim 14, wherein the chrome carbide of said chrome carbide wear body is Cr₃C₂.

16. The wear-resistant tooth of claim 13, wherein said wear body has about 25 percent high-chrome-molybdenum content and a Brinell Hardness Number (BHN) of about 700.

17. The wear-resistant tooth of claim 13, wherein the braze-joining of said wear body and said backing plate is performed in a heat treating oven at a pressure less than 1×10⁻³ Torr.

18. The wear-resistant tooth of claim 13, wherein said wear body and said backing plate are joined with a brazing alloy containing nickel, copper and manganese.

19. The wear-resistant tooth of claim 13, wherein said wear body has a generally vertical planar front face, adjoining generally parallel, vertical planar side faces, and an upper surface that is generally horizontal and planar adjacent the front face, said upper planar upper surface transitioning to a downwardly curving upper surface that makes a pointed edge with a planar lower surface.

20. The wear-resistant tooth of claim 13, wherein mating surfaces of the wear body and the backing plate are precision ground, prior to being braze-joined, so that there is no variance from absolute planarity greater than about 0.01 to 0.04 mm.
